(19) United States
(12) Patent Application Publication
(10) Pub. No.: US 2006/0051986 A1
(43) Pub. Date: Mar. 9, 2006

(54) Electric module socket

(75) Inventors: Kiyoshi Asai, Tokyo (JP); Kazuaki Kanazawa, Tokyo (JP)

Correspondence Address: DARBY & DARBY P.C., P. O. BOX 5257, NEW YORK, NY, 10150-5257, US

(73) Assignee: SMK CORPORATION, Tokyo (JP)

(21) Appl. No.: 11/158,470

(22) Filed: Jun. 21, 2005

(30) Foreign Application Priority Data
Sep. 8, 2004 (JP) 2004-260411

(51) Int. Cl. H01R 12/00

(52) U.S. Cl. 439/71

(57) ABSTRACT

An electronic module socket is provided into which camera modules of different shapes can be securely inserted. The electronic module socket includes a socket body with an insertion portion into which an electronic module is engageably inserted and a socket engagement portion that securely engages the electronic module on inner sidewalls of the insertion portion. The electronic module has a shape suitable for securely engaging with the socket engagement portion. An electronic module smaller than the insertion portion of the socket body is engageably secured via a spacer. The spacer has an inner shape that allows the electronic module to be inserted therein and an outer shape capable of being fitted into the insertion portion of the socket body. The spacer is also provided with spacer engagement portions to engage the socket engagement portions.

### INCORPORATION BY REFERENCE

The present application claims priority under 35 U.S.C. §119 to Japanese Patent Application No. 2004-260411 filed on Sep. 8, 2004. The content of JP No. 2004-260411 is incorporated herein by reference in its entirety.

### FIELD OF THE INVENTION

The present invention relates to an electronic module socket for interconnecting an electronic module such as a camera module for use with a cellular phone or the like to an electronic member such as a circuit board.

### BACKGROUND OF THE INVENTION

Conventionally, electronic modules such as a camera module for use with a cellular phone are securely maintained in electrical connection with an electronic member such as a printed circuit board. To this end, a module socket for the camera module, formed in a shape that allows for secure insertion of the camera module, is pre-installed on a printed circuit board. The camera module is then inserted into the socket to engage therewith. This allowed the contact segments provided on the camera module to be electrically connected to the contacts provided on the socket, thus establishing electrical connection between the printed circuit board and the camera module via the socket.

For example, known as an example of the aforementioned conventional technique is a camera module connector which is disclosed in Japanese Patent Laid-Open Publication No. 2004-63787, entitled “Method for implementing camera modules on circuit boards,” hereby incorporated by reference in its entirety (hereinafter referred to as a conventional example 1).

As shown in FIG. 9, in the conventional example 1, the camera module connector 114 was formed to allow for insertion of a camera module 111 therein, and provided with contact portions which were to be electrically connected to the respective contact segment portions of the camera module 111. The contact portions were disposed opposite to the contact segment portions of the camera module 111 when inserted. The camera module connector 114 was also provided at its lower end with securement contacts 115 for connecting to contacts 113 provided on a printed circuit board 112.

The camera module connector 114 configured in this manner was pre-soldered to the printed circuit board 112, and then the camera module 111 was securely inserted into the connector 114 during the assembly of components. The camera module 111 was thus securely connected to the printed circuit board 112.

This arrangement eliminated the need for soldering the contact segment portions of the camera module 111 directly to the printed circuit board 112 as commonly practiced before the conventional example 1, thereby facilitating the assembly of the camera module 111 to the printed circuit board 112.

On the other hand, the camera module connector 114 such as of the conventional example 1 has a square body which suits the camera module 111 with a side of about 10 mm. The camera module 111 is provided on the bottom surface thereof with about twenty contact portions for electrical connection between the camera module 111 and the camera module connector 114. This allows the camera module 111 and the camera module connector 114 to be electrically connected to each other. In this arrangement, there may occur unnecessary play between the camera module 111 and the connector 114 when the camera module 111 is securely inserted into the connector 114, causing the contact segment portions to be misaligned with the contact portions. This may make it not only difficult to maintain a good contact condition but also impossible to maintain electrical connection. Accordingly, the insertion portion of the connector 114 into which the camera module 111 is inserted is formed in the same size as that of the camera module 111 to provide for a good electrical connection.

However, with the advancement of technology, electronic modules such as camera modules are being currently reduced in size day by day. Additionally, it is also a common practice to manufacture modules of different grades using the same printed circuit board.

In view of these circumstances, suppose that the camera module 111 of the conventional example 1 is changed in its design, e.g., reduced in size. In this case, it is impossible to implement the camera module 111 on the printed circuit board 112 using the conventional camera module connector 114 which serves to securely connect the camera module 111 to the printed circuit board 112.

Accordingly, camera modules 111 having different grades or functions were conventionally implemented each on the printed circuit board 112 to thereby manufacture different types of cellular phones. In this case, the different grades or functions caused the camera modules 111 to be different in their shape. Thus, the camera module connector 114 had to be manufactured to suit the respective camera modules 111 in shape, so that the camera module connector 114 as well as the printed circuit board 112 had to be changed.

These problems caused an increase in manufacturing costs, thereby making it impossible to provide the products at low prices.

### SUMMARY OF THE INVENTION

In view of the aforementioned problems, the present invention has been devised. It is therefore one aspect of the invention to provide a general-purpose electronic module socket which enables shared use among electronic modules of different shapes.

To address the aforementioned problems, one embodiment of the present invention provides an electronic module socket which includes a socket into which an electronic module such as a camera module can be inserted and an adapter insertable into the socket.

### BRIEF DESCRIPTION OF THE DRAWINGS

FIG. 1 is an explanatory perspective view showing an electronic module socket according to an embodiment of the present invention when viewed diagonally from above;

FIG. 2 is a perspective view showing the socket body of the electronic module socket according to the embodiment of the present invention when viewed diagonally from above;

FIG. 3 is a perspective view showing the socket body of the electronic module socket according to the embodiment of the present invention when viewed diagonally from below;

FIG. 4 is a perspective view showing a camera module M;

FIGS. 5(a) to 5(c) are views showing the camera module M, with 5(a) a front view, 5(b) a plan view, and 5(c) a bottom view;

FIGS. 6(a) to 6(c) are views showing a camera module M′, with 6(a) a front view, 6(b) a plan view, and 6(c) a bottom view;

FIGS. 7(a) to 7(d) are views showing a spacer, with 7(a) a front view, 7(b) a plan view, 7(c) a bottom view, and 7(d) a longitudinally sectional view taken along the center of the spacer;

FIG. 8 is a perspective view showing the camera module M′ engaged with the socket body via the spacer; and

FIG. 9 is a view showing a conventional example.

### DETAILED DESCRIPTION OF THE PREFERRED EMBODIMENTS

In one embodiment, the socket body is formed in a square box with an opening at one end. The socket body is secured at its outer bottom surface to an electronic member such as a printed circuit board. The socket body is provided on its inner bottom portion with contact portions. The contacts are provided from inside to outside the socket body, where inner end portions form resilient inner contact portions and outer end portions form outer contact portions to be electrically connected to an electronic member such as a printed circuit board. This arrangement allows for electrical connection between outside and inside the socket body. The contact portions of the electronic module being inserted are brought into contact with the inner contact portions, thereby allowing the contact portions of the electronic module inside the socket body to be electrically connected to the electronic member such as a printed circuit board.

To ensure the connection, the socket engagement portions are provided on the four sidewalls of the socket body. The socket engagement portion has a resilient plate-shaped projected segment that is bent to have a horizontally projected tip, in which the segment is resiliently projected from the upper portion on the opening side of each of the four sidewall corner portions toward the opposite sidewalls.

When an electronic module is inserted into the socket body, the socket engagement portion thus provided is pushed by the electronic module to resiliently move toward the sidewall, thus enabling the electronic module to be inserted into the socket body. The electronic module thus inserted into the socket body causes the inner contact portions of the contacts to come into contact with the contact portions of the electronic module. Under this condition, the socket engagement portions are released from the pressure exerted by the electronic module and resiliently moved back to the original position to engage the electronic module inserted. This allows the electronic module to be securely engaged within the socket body. The electronic module itself is also provided with the module engagement portions, which are capable of engaging the socket engagement portions of the socket body, to oppose the socket engagement portions when inserted. Upon completion of the insertion, with the inner contact portions electrically connected positively to the contact portions, the socket engagement portions engage the module engagement portions so that the electronic module is secured within the socket body.

The electronic module socket has the socket engagement portions provided on the four sidewalls of the socket body, thereby making it possible to prevent the electronic module inserted from moving in a plane perpendicular to the direction of the insertion.

In another embodiment, when an electronic module smaller than the insertion portion provided in the socket body of the electronic module socket is secured in the socket body, a spacer for fixing the electronic module is securely fitted over the electronic module.

The spacer used at this time has an inner shape which allows the spacer to be fitted over the small electronic module desired to be secured in the electronic module socket, thereby preventing the electronic module from moving from inside the spacer when the spacer is secured in the socket body.

Furthermore, the spacer has an outer shape which is the same as that of the hollow portion or the insertion portion of the socket body and on the upper surface of which formed are the spacer engagement portions that are engageable with the socket engagement portions of the socket body. The spacer engagement portion includes a recessed portion that is positioned to oppose the socket engagement portion when the spacer is inserted into the socket body. The spacer engagement portions are configured to forcefully move the socket engagement portions toward the sidewalls of the socket body upon insertion of the spacer, whereas the spacer engagement portions are positioned below the socket engagement portion upon completion of the insertion. This allows the socket engagement portions to return to the original position due to the resilient force thereof, such that the tips of the socket engagement portions securely engage the spacer engagement portions to prevent the spacer itself from dislodging from the socket body.

The spacer configured as described above is fitted over an electronic module smaller than the insertion portion provided in the socket body, and then the electronic module fitted into the spacer is inserted into the insertion portion of the socket body. This causes the socket engagement portions of the socket body to be pushed outwardly from the spacer toward the sidewalls, thus allowing the spacer and the electronic module to be inserted into the socket body. The spacer engagement portions formed on the spacer move below the socket engagement portions, allow the inner contact portions of the socket body to come into contact with the contact portions of the electronic module for electrical connection. At this stage, the socket engagement portions move back to the original position due to the resilient force thereof, allowing the tips of the socket engagement portions to engage the spacer engagement portions. The electronic module is thus secured within the socket body via the spacer.

In one embodiment the electronic module socket includes a socket body (2) which provides an insertion portion (21a) into which an electronic module (M) is engageably inserted and which has a socket engagement portion (24) on the inner side of sidewalls (23) of the insertion portion (21a), the socket engagement portion (24) being capable of securely engaging the electronic module (M) inserted therein. An electronic module (M) suitable in shape for the insertion portion (21a) is provided with a module engagement portion (M5) which can be securely engaged with the socket engagement portion (24). An electronic module (M′) smaller than the insertion portion (21a) of the socket body (2) is engageably securely inserted into the insertion portion (21a) via a spacer (3). The spacer (3) has an inner shape which allows the smaller electronic module (M′) to be inserted therein and an outer shape which can be fitted into the insertion portion (21a) of the socket body (2). The spacer (3) is also provided with a spacer engagement portion (33) to engage the socket engagement portion (24).

With this arrangement, the electronic module socket allows an electronic module having a shape insertable into the insertion portion of the socket to be directly inserted into the insertion portion, thereby allowing the socket engagement portion to securely engage the electronic module. On the other hand, an electronic module smaller in shape than the insertion portion is inserted into a spacer which has an inner shape into which the electronic module can be inserted. The electronic module is then inserted into the insertion portion of the electronic module socket in conjunction with the spacer. This allows the spacer engagement portion provided on the spacer to engage the socket engagement portion provided on the socket body, thereby allowing the electronic module smaller in shape than the insertion portion and the spacer to be securely engaged with the socket body.

As described above, according to an embodiment of the present invention, the electronic module socket allows an electronic module smaller than the socket body to be inserted into the spacer and thereby securely inserted into the insertion portion of the electronic module socket via the spacer. The electronic module socket can thus securely engage any other electronic modules which do not suit the electronic module socket in shape. This makes it possible for the electronic module socket to be commonly used for a variety of electronic modules, thereby providing components at low costs.

### Embodiment 1

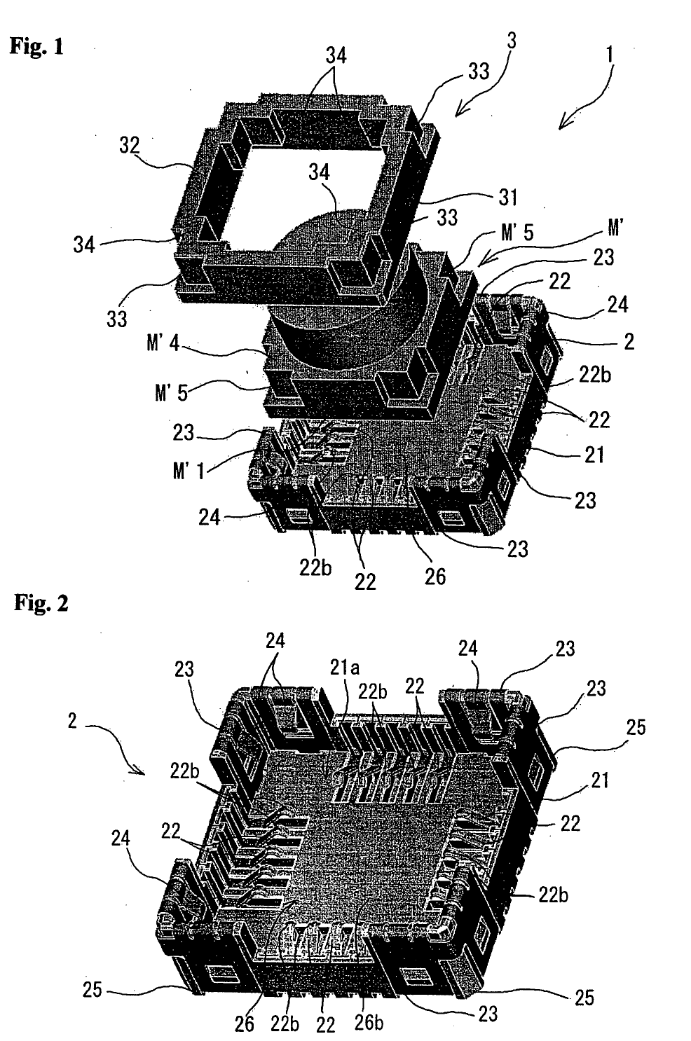

An electronic module socket according to an embodiment of the present invention is generally indicated by the reference numeral 1. As shown in FIG. 1, the electronic module socket 1 includes a socket body 2 and a spacer 3. The spacer 3 fits over an electronic module or a camera module M′ to thereby securely insert the camera module M′ into the socket body 2 via the spacer 3.

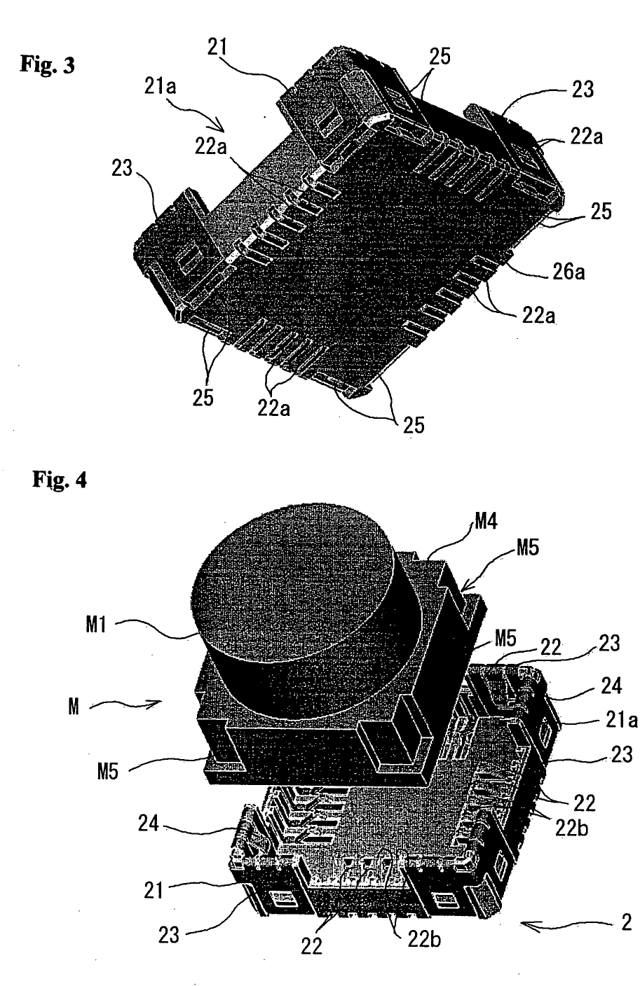

As shown in FIGS. 2 and 3, the socket body 2 is formed of a socket body or a housing 21. As shown in FIG. 2, the housing 21, which is formed in the shape of a box with an opening at one end or the upper end, has a bottom portion 26 with a plurality of contacts 22 formed thereon. The housing 21 also includes socket engagement portions 24 each at the right and left end portion of each sidewall 23 on the inner side thereof.

As shown in FIG. 3, the housing 21 is also provided at the four corners on the outer bottom surface thereof with retaining portions 25. Two retaining portions 25 are formed at each corner portion to secure the socket body 2 to an electronic member such as a printed circuit board. Furthermore, exposed on the outer bottom surface are outer contact portions 22a, each being one end of each of the contacts 22. The outer contact portions 22a are fixed to an electronic member such as a printed circuit board to which the socket body 2 is secured, allowing the contacts 22 to electrically connect between the inside and outside of the socket body 2. These retaining portions 25 and the outer contact portions 22a are each fixed to an electronic member such as a printed circuit board using paste solder or the like.

The housing 21 is configured such that inverse “U” curved metal members are fixed to each of the sidewalls 23 on a base which is formed of an insulating material in the shape of a box with an opening at one end. The metal member on both end portions of the sidewalls 23 is partially cut inside the housing 21 and resiliently protruded inwardly, thereby forming the socket engagement portions 24. The socket engagement portion 24 has a tip positioned approximately at the center of the sidewall height and is formed in the shape of a segment protruding inwardly from the sidewall 23. When depressed, the segment can resiliently move toward the sidewall 23. The housing 21 configured as such defines an insertion portion 21a or a space formed in the shape of a box with an opening at one end for allowing the camera module M to be engagedly inserted therein.

A plurality of contacts 22, which are formed of an electrically conductive resilient metal plate, are fixed to the bottom portion 26 of the housing 21. One end of the contact 22 is provided on an outer bottom surface 26a of the housing 21 to form the outer contact portion 22a, while the other end is protruded from an inner bottom surface 26b of the housing 21 to form an inner contact portion 22b. The outer contact portions 22a are securely positioned on the outer bottom surface 26a. The outer contact portions 22a are electrically connected to an electronic member such as a printed circuit board which is to be placed on the outer bottom surface 26a using paste solder or the like. The inner contact portion 22b forms a projected contact with its end portion bent in the shape of an arc and is kept resiliently protruded upwardly from the inner bottom surface 26b. The contacts 22 configured and placed in this manner allow for electrically connecting between the camera module M to be inserted into the insertion portion 21a of the housing 21 and an electronic member such as a printed circuit board to which the outer bottom surface 26a of the socket body 2 is secured.

Now, detailed descriptions will be made to the camera module M which suits in shape to the socket body 2. For purposes of description, this embodiment employs the camera module M or the camera module M′ as an electronic module; however, other electronic modules may also be employed.

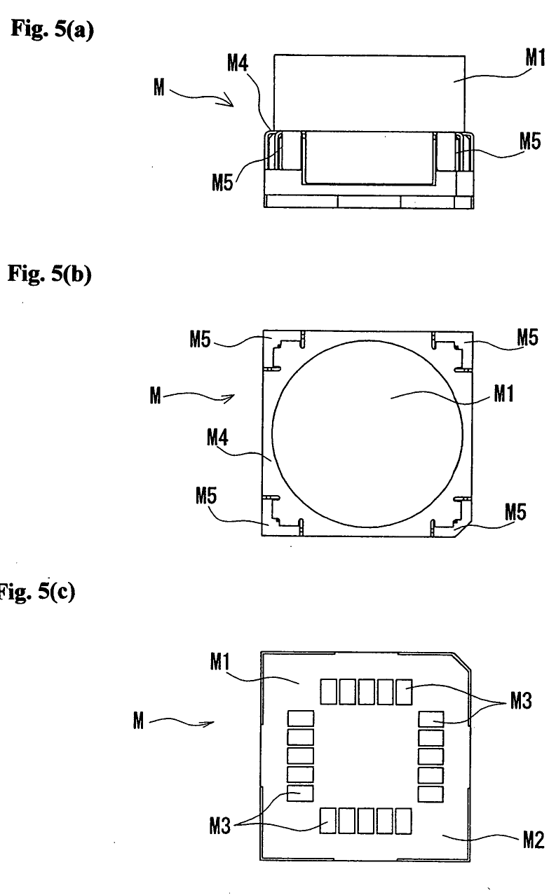

The camera module M constitutes a compact camera to be mounted to cellular phones or the like, and has the shape of a square with one side of about 10 mm. As shown in FIGS. 4 and 5(a) to 5(c), the camera module M has a module housing M1 which includes a lens portion or the like therein and which is formed in the shape of the insertion portion 21a of the socket body 2. The module housing M1 is provided on its bottom surface M2 with as many as about twenty contacts M3, which allow for power supply to the camera module M and output of image information captured. The contacts M3 are disposed to oppose the inner contact portions 22b provided on the inner bottom surface 26b of the housing 21, and brought into contact with the inner contact portions 22b when the module housing M1 is inserted into the housing 21. The module housing M1 is provided at each corner of a square upper surface M4 with a module engagement portion M5 by cutting. The module engagement portions M5 are disposed so as to oppose the socket engagement portions 24 of the housing 21 when the camera module M is inserted into the insertion portion 21a causing the contacts M3 to depress the inner contact portions 22b of the contacts 22 for securely maintaining electrical connections therebetween. For secure insertion of the camera module M, the socket engagement portions 24 are securely engaged with the module engagement portions M5 while the contacts M3 are forced to abut against the inner contact portion 22b to prevent the camera module M from being dislodged from the insertion portion 21a. Accordingly, since two socket engagement portions 24 are disposed at right angles at each corner portion in the socket body 2, the module engagement portion M5 to be formed at each corner portion is cut in the shape of a letter “L” in its plan view so as to oppose the socket engagement portion 24.

Since the camera module M configured as described above suits the socket body 2 in shape and size, it is possible to directly insert the camera module M to the insertion portion 21a of the socket body 2 to securely engage the socket engagement portions 24 with the module engagement portions M5.

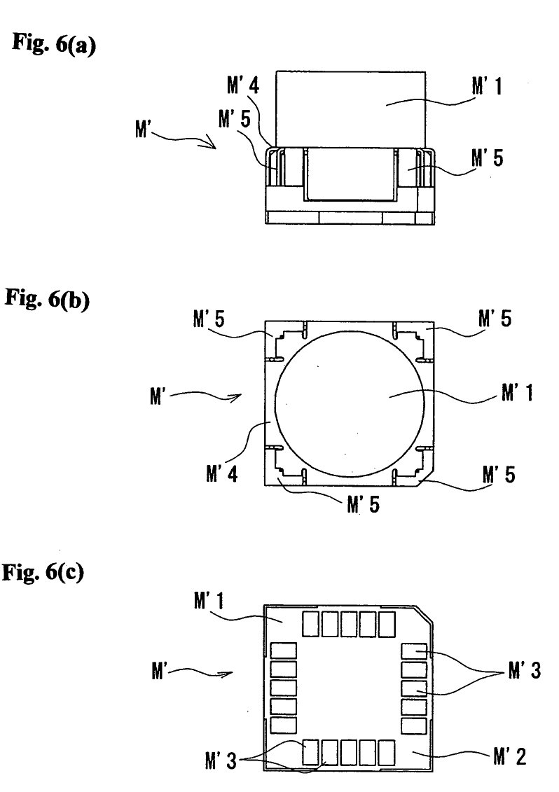

Now, an explanation is given to a case where a camera module M′ which is not compatible with the socket body 2 according to an aspect of the present invention is securely inserted therein. In this embodiment, the camera module M′ is shaped in a square of a side of about 8 mm, which is slightly smaller than the insertion portion 21a of the socket body 2. As shown in FIGS. 6(a) to 6(c), a module housing M′1 which includes a lens or the like therein is similar in shape to the insertion portion 21a of the socket body 2. The module housing M′1 is provided on its bottom surface M′2 with as many as about twenty contacts M′3, which allow for power supply to the camera module M′ and output of image information captured. The contacts M′3 are disposed to oppose the inner contact portions 22b provided on the inner bottom surface 26b of the housing 21, and brought into contact with the inner contact portions 22b when the module housing M′1 is inserted into the housing 21. The other configuration of the camera module M′ is the same as that of the camera module M.

Now, an explanation is given to the spacer 3 which serves to securely connect the aforementioned camera module M′ to the socket body 2.

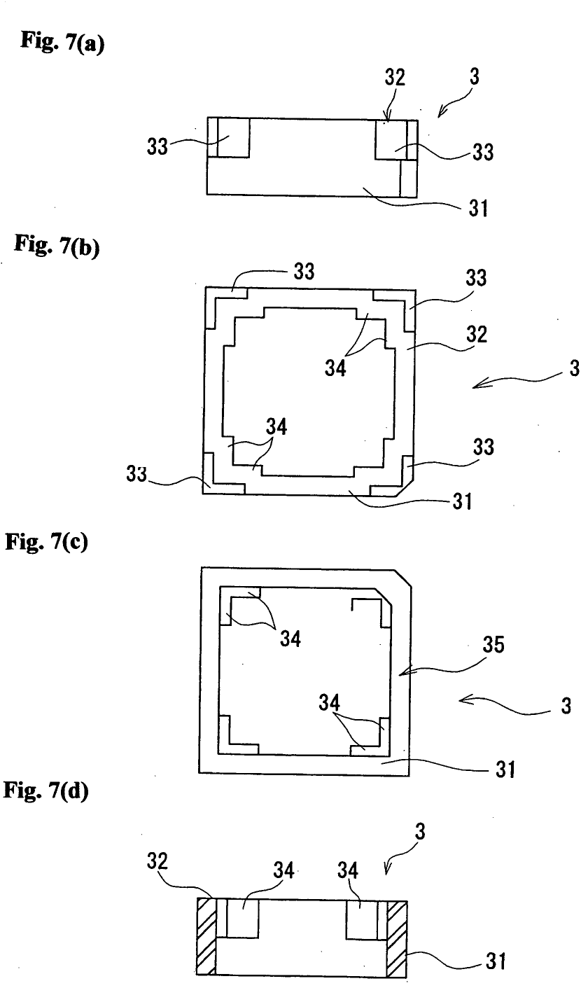

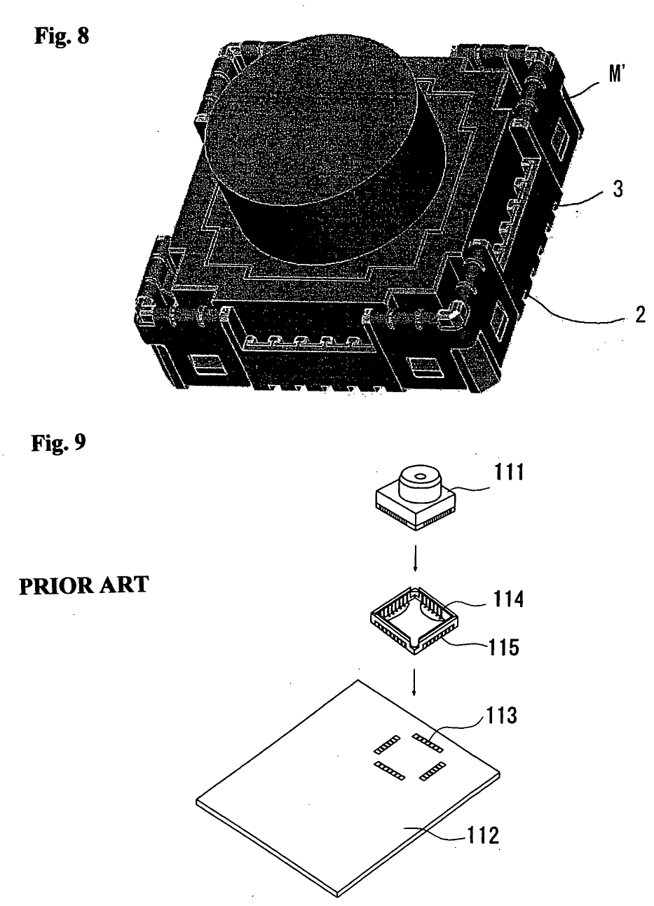

As shown in FIGS. 1, 7(a) to 7(d), and 8, the spacer 3 includes a hollow frame 31, which has an outer shape insertable into the socket body 2 and capable of engaging the socket engagement portions 24. That is, the frame 31 has an outer shape which is formed to be the same as the outer shape of the camera module M below the upper surface thereof. Then, with the camera module M′ fitted in the spacer 3, the spacer 3 is securely inserted together with the camera module M′ into the insertion portion 21a of the socket body 2. Accordingly, like the module engagement portions M5 of the camera module M, spacer engagement portions 33 which can engage the socket engagement portions 24 are formed at the corner portions of a square upper surface 32 by cutting.

On the other hand, the spacer 3 has an inner shape which allows the camera module M′ to be inserted therein and which has the length of one side equal to that of an outer side of the camera module M′. Additionally, the spacer 3 includes spacer inner engagement portions 34 which are protruded inwardly from the upper surface 32. The spacer inner engagement portions 34 are formed to protrude in the shape of a letter “L” in a plan view to oppose module engagement portions M′5 of the camera module M′. The spacer inner engagement portions 34 are formed in this manner. Upon insertion of the camera module M′ from a bottom surface 35 of the spacer 3, this arrangement allows the module engagement portions M′5 to abut against the spacer inner engagement portions 34, thereby preventing the camera module M′ from moving upwardly. Accordingly, with the camera module M′ engaged with the spacer 3, the outer shape of the camera module M′ and the spacer 3 joined together is the same as that of the camera module M. Thus, when the spacer 3 and the camera module M′ are inserted into the insertion portion 21a of the socket body 2 with the module engagement portions M′5 abutted against the spacer inner engagement portions 34, the camera module M′ is securely inserted into the socket body 2.

In this embodiment, the same size is employed from the bottom surface M2 to the module engagement portion M5, from the bottom surface M′2 to the module engagement portion M′5, and from the bottom surface 35 to the respective lower ends of the spacer engagement portion 33 and the spacer inner engagement portion 34. In this arrangement, the camera module M or the camera module M′ and the spacer 3 are inserted into the socket body 2 without any movement in the direction of height in either case, and depressed by the inner contact portion 22b of the socket body 2, thereby providing a good electrical connection. However, with respect to the size from the bottom surface, the spacer inner engagement portion 34 of the spacer 3 and the module engagement portion M′5 of the camera module M′ are not necessarily the same as the module engagement portion M5 and the spacer engagement portion 33. It is sufficient if the spacer inner engagement portion 34 is the same in the size from the bottom surface as the module engagement portion M′5.

On the other hand, the socket engagement portions 24 of the socket body 2 are provided at two positions of each corner portion in this embodiment. However, the socket engagement portions 24 may be provided at two positions only of a pair of opposite corner portions, or alternatively may be provided on both the right and left sides of a pair of opposite sidewalls 23. In other words, what is essential is to provide a good electrical connection between the inner contact portion 22b and the camera module M to be inserted into the insertion portion 21a or the camera module M′ fitted into the spacer 3. Accordingly, the module engagement portions M′5 of the camera module M′ and the spacer engagement portions 33 of the spacer 3 may also be positioned to engage the socket engagement portions 24, i.e., opposite to the socket engagement portions 24, respectively.

Furthermore, in this embodiment, the shape of the insertion portion 21a of the socket body 2 and the outer shape of the spacer 3 are square in plan view. However, the insertion portion 21a and the spacer 3 may have a rectangular, circular, elliptical, or any other shape. In other words, any shape may be accepted so long as the spacer 3 to be inserted into the insertion portion 21a can be positioned and fixed. Moreover, the socket engagement portion 24 and the spacer engagement portion 33 are also not limited to a particular shape or engagement method so long as they are positioned opposite to each other allowing for engagement.

Still furthermore, the inner shape of the spacer 3 has been determined as described above in order to allow the camera module M′ to be engageably fitted therein. However, when any other shape is employed for the outer shape of a camera module smaller than the insertion portion 21a, the inner shape of the spacer 3 may be formed to suit the outer shape. Thus, any shape may be employed as the inner shape of the spacer 3 so long as the shape can prevent the camera module smaller than the insertion portion 21a from moving toward the upper surface.

The present invention is applicable to an electronic module socket for electrically connecting and securing an electronic module to a circuit board, a connector for the electronic module, and a method for implementing an electronic module using them to a circuit board. In particular, the present invention is available for manufacturing a compact electronic device such as cellular phones.

What is claimed is:

1. An electronic module socket comprising:
a socket body including an insertion portion into which an electronic module is inserted; and
the insertion portion including a socket engagement portion on inner sides of sidewalls of the insertion portion (21a), the socket engagement portion engages the electronic module inserted therein;
wherein an electronic module suitable in shape for the insertion portion is provided with a module engagement portion that is engaged with the socket engagement portion.

2. The electronic module socket of claim 1, wherein an electronic module smaller than the insertion portion of the socket body is securely inserted into the insertion portion, further comprising:
a spacer, the spacer having an inner shape that allows the smaller electronic module to be inserted therein and an outer shape which can be fitted into the insertion portion of the socket body, the spacer including a spacer engagement portion that engages the socket engagement portion
